(19) United States
(12) Patent Application Publication
(10) Pub. No.: US 2014/0001675 A1
(43) Pub. Date: Jan. 2, 2014

(54) NANOIMPRINTING METHOD AND NANOIMPRINTING APPARATUS FOR EXECUTING THE NANOIMPRINTING METHOD

(71) Applicant: FUJIFILM Corporation, Tokyo (JP)

(72) Inventors: Kazuharu NAKAMURA, Haibara-gun (JP); Satoshi WAKAMATSU, Haibara-gun (JP)

(73) Assignee: FUJIFILM Corporation, Tokyo (JP)

(21) Appl. No.: 14/019,622

(22) Filed: Sep. 6, 2013

(30) Foreign Application Priority Data
Mar. 9, 2011 (JP) 2011-051031

(51) Int. Cl. B29C 59/02

(52) U.S. Cl. CPC B29C 59/022
USPC 264/293; 425/385

(57) ABSTRACT

In a nanoimprinting method, an assembly, of which the entire surface is directly exposable to the environment, is supported by a pressure vessel by a support member such that fluid pressure from the environment operates on the entire surface of the assembly. Gas is introduced into the pressure vessel, and fluid pressure exerted by the gas presses a mold and a substrate against each other. Thereby, pressing with uniform pressure onto a curable resin coated surface can be realized in nanoimprinting that employs a mesa type mold and/or a mesa type substrate to be processed, and the occurrence of residual film fluctuations can be suppressed.

### TECHNICAL FIELD

The present invention is related to a nanoimprinting method that employs a nanoimprinting mold having a predetermined pattern of protrusions and recesses on the surface thereof, and a nanoimprinting apparatus for executing the nanoimprinting method.

### BACKGROUND ART

There are high expectations regarding utilization of pattern transfer techniques that employ a nanoimprinting method to transfer patterns onto resist coated on objects to be processed, in applications to produce magnetic recording media such as DTM (Discrete Track Media) and BPM (Bit Patterned Media) and semiconductor devices.

The nanoimprinting method is a development of the well known embossing technique employed to produce optical discs. In the nanoimprinting method, an original (commonly referred to as a mold, a stamper, or a template), on which a pattern of protrusions and recesses is formed, is pressed against curable resin coated on a substrate to be processed. Pressing of the original onto the curable resin causes the curable resin to mechanically deform or to flow, to precisely transfer the fine pattern. If a mold is produced once, nano level fine structures can be repeatedly molded in a simple manner. Therefore, the nanoimprinting method is an economical transfer technique that produces very little harmful waste and discharge. Therefore, there are high expectations with regard to application of the nanoimprinting method in various fields.

When pressing a mold against curable resin coated on a substrate during a nanoimprinting operation, it is important to press the mold against the surface coated by the curable resin with uniform pressure. The degree of importance of this factor is increasing accompanying further refinements to patterns of protrusions and recesses. In the case that the pressure is not uniform, positional shifts may occur during pattern transfer due to horizontal shifting and rotational shifting of the mold. In addition, there are cases that the pattern of protrusions on the mold will be damaged if the pressure is not uniform.

Therefore, Japanese Patent No. 3987795 discloses a nanoimprinting method that employs a flexible sealing cover 9, in which a mold 5 having a fine pattern of protrusions and recesses on the surface thereof and a substrate 7 coated with curable resin 6 are placed and sealed. An assembly 8 constituted by the mold 5, the curable resin 6, and the substrate 7 are exposed to fluid pressure via the sealing cover 9. The isotropic nature of fluid pressure is utilized to press the mold 5 and the substrate 7 against each other with uniform pressure.

Generally, nanoimprinting operations such as that described above are executed utilizing molds on which patterns of protrusions and recesses are formed on the entireties of the surfaces of flat substrates. However, in the case that such a mold is utilized, the entirety of the surface on which the pattern of protrusions and recesses is formed comes into close contact with the curable resin, and the release properties (the ease with which the mold is separated from the curable resin) deteriorates. There is another problem that the range in which the curable resin flows cannot be controlled, because the curable resin flows throughout the entirety of the surface on which the pattern of protrusions and recesses is formed.

Therefore, nanoimprinting methods that utilize mesa type molds have been being developed recently, as disclosed in Japanese Unexamined Patent Publication No. 2009-170773. Mesa type molds are molds having a mesa shaped structure as exemplified by the molds 1 and 2 of FIG. 12A, FIG. 12B, and FIG. 12C, for example. FIG. 12A is a perspective view that schematically illustrates an example of a mesa type mold, FIG. 12B is a sectional diagram that schematically illustrates a cross section of the mesa type mold taken along the line A-A of FIG. 12A, and FIG. 12C is a sectional diagram that schematically illustrates another example of a mesa type mold. Specifically, the mold 1 illustrated in FIG. 12A and FIG. 12B (and the mesa type mold 2 illustrated in FIG. 12C) is equipped with a planar support portion 11 (21) and a mesa portion 12 (22) provided on a surface S1 (a base surface) of the support portion 11 (21) and having a predetermined height D2 from the base surface S1. A patterned region R1, in which a fine pattern 13 (23) of protrusions and recesses is formed, is provided on the mesa portion 12 (22). Reference numerals 15 and 16 denote the flange portions of the molds 1 and 2, respectively. In the case that a mesa type mold is utilized, when the mold is pressed against curable resin which is coated on a substrate to be processed, range in which the curable resin flows can be controlled, and therefore, the aforementioned problems are resolved.

### DISCLOSURE OF THE INVENTION

It is also important for mesa type molds to be pressed against surfaces coated with curable resin with uniform pressure. If the method disclosed in Japanese Patent No. 3987795 is applied to nanoimprinting employing mesa type molds, the mesa type molds cannot be pressed against substrates with uniform pressure. This is because fluid pressure is applied from a single direction onto a flange portion 15 (the portion of the support portion 11 at which the mesa portion 12 is not formed) of the mesa type mold 1 and the portion of a substrate 7 that faces to the flange portion 15, as illustrated in FIG. 13. The fluid pressure causes the mold 1 and the substrate 7 to bend, and a pressure distribution is generated between the surface coated with curable resin and the mesa portion. Such a pressure distribution is a factor that may result in residual film fluctuations (fluctuations in the thickness of residual film).

The same problem exists in the case that a substrate to be processed has a mesa portion as well.

The present invention has been developed in view of the foregoing problems. It is an object of the present invention to provide a nanoimprinting method and a nanoimprinting apparatus for executing the nanoimprinting method, that realize pressing of a mold against a surface coated with curable resin at a uniform pressure to suppress the generation of fluctuations in residual film, in nanoimprinting that employs a mesa type mold and/or a mesa type substrate.

In order to achieve the aforementioned objective, the present invention provides a nanoimprinting method that employs a mold having a fine pattern of protrusions and recesses on the surface thereof, and a substrate having a surface coated with curable resin, at least one of the mold and the substrate having a mesa portion, on which the pattern of protrusions and recesses or the surface coated with curable resin is formed, characterized by comprising:

placing the pattern of protrusions and recesses and the cured resin coated on the surface of the substrate in contact with each other to form an assembly constituted by the mold, the curable resin, and the substrate;

supporting the assembly, of which the entire surface is directly exposable to the environment, with a support member within a pressure vessel such that fluid pressure of the environment operates on substantially the entire surface of the assembly;

introducing a gas into the pressure vessel;

pressing the mold and the substrate against each other with fluid pressure of the gas; and

separating the mold and the substrate.

In the present specification, “at least one of the mold and the substrate having a mesa portion, on which the pattern of protrusions and recesses or the surface coated with curable resin is formed” refers to at least one of the mold and the substrate having a mesa portion. In the case that the mold has the mesa portion, the pattern of protrusions and recesses is formed on the mesa portion. In the case that the substrate has the mesa portion, the surface coated with curable resin is formed on the mesa portion.

With respect to the assembly, “of which the entire surface is directly exposable to the environment” refers to a state in which neither the entirety nor a portion of the assembly is sealed when the assembly is not being supported by the support member is considered. In this state, the surfaces of the assembly (that is, the surfaces of the mold, the curable resin, and the substrate other than the contact surface between the mold and the curable resin, the contact surface between the curable resin and the substrate, and the surface that defines the closed space formed between the pattern of protrusions and recesses and the curable resin) are directly exposable to the environment. Accordingly, that the contact points or the contact surface between the assembly and the supporting member are not directly exposed to the environment when the assembly is actually being supported within the pressure vessel is allowable.

The expression “operates on substantially the entire surface of the assembly” refers to the assembly and the support member being in contact with each other at regions (points or lines, for example) which are comparatively small with respect to the size of the assembly.

In the nanoimprinting method of the present invention, it is preferable for the assembly to be supported by the support member at a portion of the assembly other than a portion corresponding to the pattern of protrusions and recesses.

In the present specification, the “portion corresponding to the pattern” refers to a predetermined portion of the assembly, which is a region in which the pattern of protrusions and recesses is formed and a portion onto which the region is projected in plan view (viewed from a direction perpendicular to the surface coated with curable resin).

In the nanoimprinting method present invention, it is preferable for the support member to be of an annular shape; and for the support member to support the portion of the assembly other than the portion corresponding to the pattern of protrusions and recesses by positioning the portion corresponding to the pattern of protrusions and recesses within the inner circumference of the annular shape.

In the present specification, an “annular shape” may refer to shapes in which portions of rings are missing.

Alternatively, in the nanoimprinting method present invention, it is preferable for the support member to be constituted by three or more protrusions; and for the support member to support the portion of the assembly other than the portion corresponding to the pattern of protrusions and recesses with the three or more protrusions.

In the nanoimprinting method of the present invention, it is preferable for the assembly to be supported by the support member supporting only one of the mold and the substrate.

In the nanoimprinting method of the present invention, it is preferable for the fluid pressure to be within a range from 0.1 MPa to 5 MPa.

In the nanoimprinting method of the present invention, it is preferable for the curable resin to be coated on the substrate such that the thickness of the coated curable resin is greater than or equal to differences in the surface height of the substrate.

In the present specification, the expression “differences in the surface height of the substrate” refers to relative differences in heights between high portions and low portions of the substrate due to undulations in the surface thereof.

In the nanoimprinting method of the present invention, it is preferable for the mold and the substrate to be separated while applying heat to the curable resin.

A nanoimprinting apparatus of the present invention is that which is utilized to execute the nanoimprinting method of the present invention, and is characterized by comprising:

a pressure vessel, for housing an assembly constituted by a mold having a fine pattern of protrusions and recesses on the surface thereof, and a substrate having a surface coated with curable resin, formed by placing the pattern of protrusions and recesses and the cured resin coated on the surface of the substrate in contact with each other, filled with a gas;

a support member provided within the pressure vessel, for supporting the assembly, of which the entire surface is directly exposable to the environment such that fluid pressure of the environment operates on substantially the entire surface of the assembly; and

a gas introducing means, for introducing a gas into the pressure vessel.

In the nanoimprinting apparatus of the present invention, it is preferable for the support member to support the assembly at a portion of the assembly other than a portion corresponding to the pattern of protrusions and recesses.

In the nanoimprinting apparatus of the present invention, it is preferable for the support member to be of an annular shape, or alternatively to be constituted by three or more protrusions.

The nanoimprinting method of the present invention introduces gas into the pressure vessel while supporting the assembly, of which the entire surface is directly exposable to the environment, with a support member within the pressure vessel such that fluid pressure of the environment operates on substantially the entire surface of the assembly. The fluid pressure of the gas presses the mold and the substrate against each other. By adopting this configuration, uniform fluid pressure is applied to a flange portion of the mold and a portion of the substrate that faces the flange portion. Thereby, bending of the mold and the substrate can be prevented. Pressing of a mold against a surface coated with curable resin at a uniform pressure is realized in nanoimprinting that employs a mesa type mold and/or a mesa type substrate, and it becomes possible to suppress the generation of fluctuations in residual film.

The nanoimprinting apparatus of the present invention is characterized by being equipped with: a pressure vessel, for housing an assembly constituted by a mold having a fine pattern of protrusions and recesses on the surface thereof, and a substrate having a surface coated with curable resin, formed by placing the pattern of protrusions and recesses and the cured resin coated on the surface of the substrate in contact with each other, filled with a gas; a support member provided within the pressure vessel, for supporting the assembly, of which the entire surface is directly exposable to the environment such that fluid pressure of the environment operates on substantially the entire surface of the assembly; and a gas introducing means, for introducing a gas into the pressure vessel. Accordingly, the nanoimprinting apparatus of the present invention is capable of executing the nanoimprinting method of the present invention. Pressing of a mold against a surface coated with curable resin at a uniform pressure is realized in nanoimprinting that employs a mesa type mold and/or a mesa type substrate, and it becomes possible to suppress the generation of fluctuations in residual film.

### BRIEF DESCRIPTION OF THE DRAWINGS

FIG. 1 is a sectional diagram that schematically illustrates a nanoimprinting apparatus according to a first embodiment of the present invention.

FIG. 2A is a diagram in plan view that schematically illustrates a first embodiment of a setting stage for a substrate of the nanoimprinting apparatus of the present invention.

FIG. 2B is a diagram in plan view that schematically illustrates a second embodiment of a setting stage for a substrate of the nanoimprinting apparatus of the present invention.

FIG. 2C is a diagram in plan view that schematically illustrates a first embodiment of a supporting member for a mold of the nanoimprinting apparatus of the present invention.

FIG. 3A is a collection of sectional diagrams that schematically illustrates the steps of a nanoimprinting method according to a first embodiment of the present invention.

FIG. 3B is a collection of sectional diagrams that schematically illustrates the steps of the nanoimprinting method according to the first embodiment of the present invention.

FIG. 4 is a sectional diagram that schematically illustrates the manner in which fluid pressure operates on an assembly in the present invention.

FIG. 5 is a diagram in plan view that schematically illustrates a third embodiment of a setting stage for a substrate of the nanoimprinting apparatus of the present invention.

FIG. 6A is a sectional diagram that schematically illustrates the manner in which a mold and a substrate coated with curable resin are placed in contact with each other using a setting stage equipped with a first embodiment of a contacting mechanism.

FIG. 6B is a sectional diagram that schematically illustrates the manner in which a mold and a substrate coated with curable resin are placed in contact with each other using a setting stage equipped with a second embodiment of a contacting mechanism.

FIG. 7 is a sectional diagram that schematically illustrates a nanoimprinting apparatus according to a second embodiment of the present invention.

FIG. 8A is a collection of sectional diagrams that schematically illustrates the steps of a nanoimprinting method according to a second embodiment of the present invention.

FIG. 8B is a collection of sectional diagrams that schematically illustrates the steps of the nanoimprinting method according to the second embodiment of the present invention.

FIG. 9 is a sectional diagram that schematically illustrates a nanoimprinting apparatus according to a third embodiment of the present invention.

FIG. 10 is a diagram in bottom view that schematically illustrates a third embodiment of a supporting member for a mold of the nanoimprinting apparatus of the present invention.

FIG. 11 is a sectional diagram that schematically illustrates the manner in which an assembly constituted by a conventional mold, curable resin, and a substrate are sealed within a sealing cover, and nanoimprinting is performed under fluid pressure.

FIG. 12A is a perspective view that schematically illustrates an example of a mesa type mold.

FIG. 12B is a sectional diagram that schematically illustrates a cross section of the mesa type mold taken along the line A-A of FIG. 12A.

FIG. 12C is a sectional diagram that schematically illustrates another example of a mesa type mold.

FIG. 13 is a sectional diagram that schematically illustrates the manner in which an assembly constituted by a mesa type mold, curable resin, and a substrate are sealed within a sealing cover, and nanoimprinting is performed under fluid pressure.

### BEST MODE FOR CARRYING OUT THE INVENTION

Hereinafter, embodiments of the present invention will be described with reference to the attached drawings. However, the present invention is not limited to the embodiments to be described below. Note that the dimensional scale ratios, etc. of the constituent elements within the drawings are not necessarily as the actual scale ratios in order to facilitate visual understanding.

### First Embodiment

### (Nanoimprinting Apparatus)

First, a nanoimprinting apparatus for executing a nanoimprinting method according to a first embodiment will be described. The nanoimprinting method of the first embodiment is executing employing a nanoimprinting apparatus 100 illustrated in

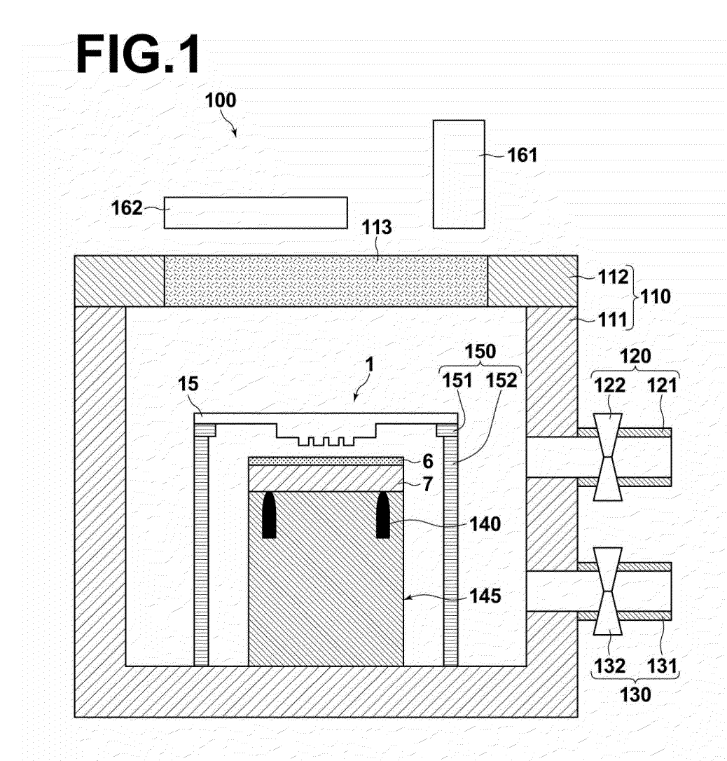

FIG. 1. The nanoimprinting apparatus 100 of FIG. 1 is equipped with: a pressure vessel 110; a gas introducing section 120 that introduces gas into the pressure vessel 110; an exhaust section 130 for exhausting gas from the interior of the pressure vessel 110; a substrate setting stage 145 equipped with a substrate supporting member 140 for supporting a substrate 7 to be processed; a mold supporting member 150 for supporting a mold 1; a light receiving device 161 for positioning a pattern of protrusions and recesses; and an exposure light source 162 for exposing photocurable resin. Note that FIG. 1 also illustrates the mold 1 having a pattern 13 of fine protrusions and recesses, and the substrate 7 to be processed, a surface of which is coated with photocurable resin 6. An assembly is formed by placing the mold 1 and the substrate 7 in contact such that the pattern 13 of protrusions and recesses and the photocurable resin 6 are in contact with each other.

### (Mesa Type Mold)

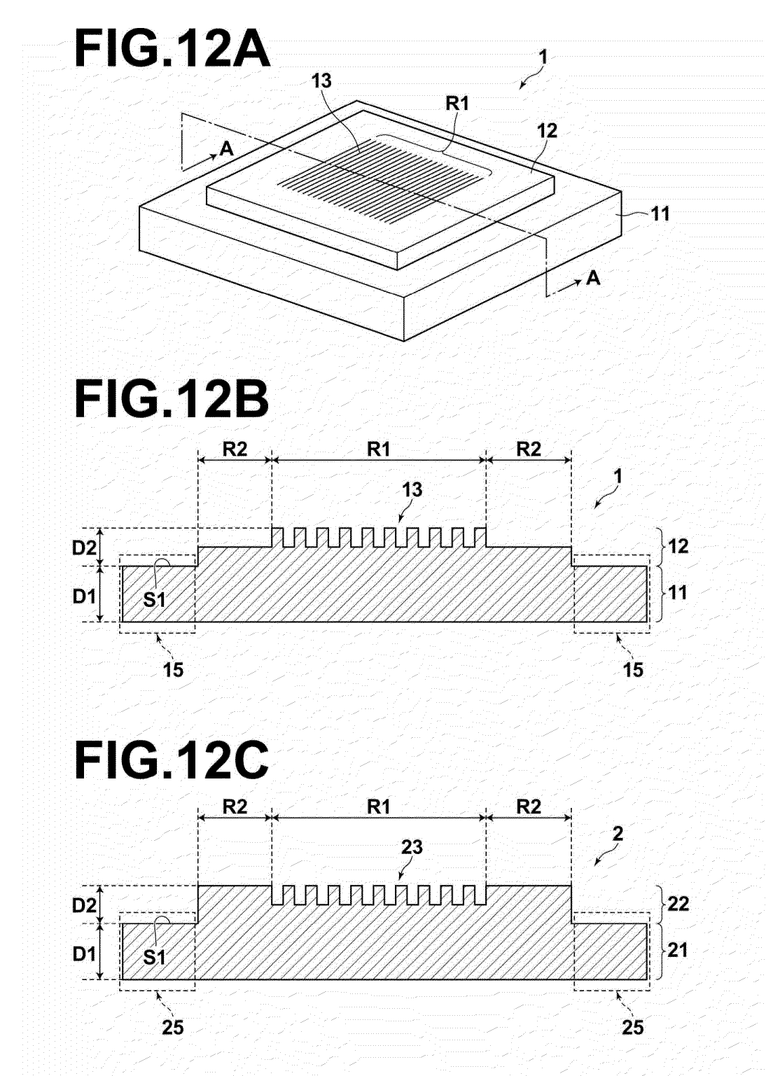

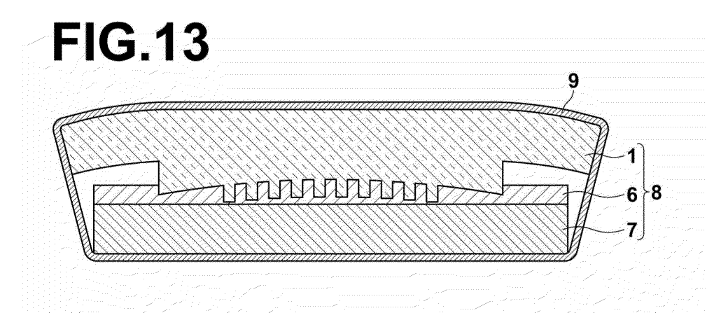

The mold 1 has a mesa type structure as illustrated in FIGS. 12A and 12B. The mesa type mold 1 may be produced by administering a mesa process (a process that removes substrate material about the periphery of a mesa portion such that the mesa portion remains) onto a planar substrate, and then by forming a pattern of protrusions and recesses on the surface of the mesa portion. An example of a method for forming the pattern of protrusions and recesses is as follows. First, a mesa processed Si base material is coated by a photoresist liquid such as a novolac resin or an acrylic resin, e.g. PMMA (Polymethyl Methacrylate), by the spin coat method or the like, to form a photoresist layer. Next, an electron beam modulated corresponding to a predetermined line pattern is irradiated onto the Si base material while the Si base material is scanned on an XY stage, to expose a pattern of protrusions and recesses on the surface of the photoresist layer within a 10 mm square region. Thereafter, the photoresist layer is developed to remove the exposed portions. Finally, etching is performed to a predetermined depth using the photoresist layer after the exposed portions are removed as a mask, to obtain a Si mold having the predetermined pattern. In addition, patterns other than the pattern to be transferred, such as alignment marks, may be formed in a region R2 other than a patterned region of the mesa portion 12.

A quartz substrate may be employed as the material of the mold 1. In the case that a fine pattern is to be formed on a quartz substrate, it is necessary to use laminated structure constituted by a metal layer and a photoresist layer as the mask when processing the substrate. An example of a method for processing a quartz substrate is as follows. Dry etching is performed using a photoresist layer as a mask, to form a pattern of protrusions and recesses corresponding to a pattern of protrusions and recesses formed in the photoresist layer on a metal layer. Then, dry etching is further performed on the quartz substrate using the metal layer as an etching stop layer, to form a pattern of protrusions and recesses on the quartz substrate. Thereby, a quartz mold having a predetermined pattern is obtained. In addition, pattern transfer using imprinting may be performed instead of electro beam lithography, as a method for forming the pattern.

Further, the mold 1 may be that which has undergone a mold release process to improve separation properties between the photocuring resin and the mold. Examples of such a mold include: those which have been processed by silicone or fluorine silane coupling agents. Commercially available mold release agents such as Optool DSX by Daikin Industries K.K. and Novec EGC-1720 by Sumitomo 3M K.K. may be favorably employed.

In the mold 1 and the mold 2, the support portion 11 and the mesa portion 12 are integrally formed, by the planar substrate undergoing the mesa process. As alternatives to the aforementioned quartz, the material of the mesa type substrate may be: a metal, such as silicon, nickel, aluminum, chrome, steel, tantalum, and tungsten; oxides, nitrides, and carbides thereof. Specific examples of the material of the mesa type substrate 10 include silicon oxide, aluminum oxide, quartz glass, Pyrex™, glass, and soda glass. The embodiment illustrated in FIG. 1 performs exposure through the mold 1. Therefore, the mold 1 is formed by a light transmissive material. In the case that exposure is performed from the side of the substrate 2, it is not necessary for the material of the mold 1 to be light transmissive.

The thickness D1 of the support portions 11 and 21 is within a range from 300 μm to 10 mm, and preferably within a range from 400 μm to 500 μm. If the thickness D1 is less than 300 μm, there is a possibility that the mold will be damaged during a mold separating process, and if the thickness D1 is greater than 10 mm, flexibility that enables the mold to be subject to fluid pressure will be lost. The thickness D2 of the mesa portions 12 and 22 is within a range from 100 μm to 10 mm, more preferably within a range from 10 μm to 500 μm, and most preferably within a range from 10 μm to 50 μm. If the mesa type mold is employed to perform nanoimprinting operations by the step and repeat method, it is necessary for the thickness D2 of the mesa portions 12 and 22 to be greater than that of the pattern on the photocurable resin. The lower limit of the thickness D2 was set to 100 nm, taking the fact that combined height of residual film and protrusions of patterns formed on photocurable resin is generally approximately 100 nm in the case that patterns having line widths of several tens of run are formed on photocurable resin by a nanoimprinting process into consideration. Meanwhile, flexibility that enables the mold to be subject to fluid pressure will be lost if the thickness D2 is too great. Therefore, the upper limit of the thickness D2 was set to 10 mm.

### (Substrate)

In the case that the mold 1 has light transmissive properties, the shape, the structure, the size, and the material of the substrate 7 are not particularly limited, and may be selected as appropriate according to intended use. The surface of the substrate 7 on which the pattern is to be transferred is the surface which is coated with photocurable resin. For example, the substrate 7 generally is of a discoid shape in the case that nanoimprinting is performed to produce a data recording medium. With respect to the structure of the substrate, a single layer substrate may be employed, or a laminated substrate may be employed. With respect to the material of the substrate, the material may be selected from among known materials for substrates, such as silicon, nickel, aluminum, glass, and resin. These materials maybe utilized singly or in combination. The thickness of the substrate is not particularly limited, and may be selected according to intended use. However, it is preferable for the thickness of the substrate to be 0.05 mm or greater, and more preferably 0.1 mm or greater. If the thickness of the substrate 7 is less than 0.05 mm, there is a possibility that the substrate 7 will flex during close contact with the mold 1, resulting in a uniform close contact state not being secured. On the other hand, in the case that the mold 1 is not formed by a light transmissive material, a quartz substrate is employed to enable exposure of the photocurable resin. The quartz substrate is not particularly limited as long as the thickness thereof is 0.3 mm or greater. The quartz substrate may be that which is coated by a silane coupling agent. In addition, the quartz substrate may be that which has a metal layer of Cr, W, Ti, Ni, Ag, Pt, or Au provided on the surface thereof; or that which has a metal oxide layer of CrO₂, WO₂, or TiO₂ provided on the surface thereof. Further, the quartz substrate may be that in which a metal layer of Cr, W, Ti, Ni, Ag, Pt, or Au or a metal oxide layer of CrO₂, WO₂, or TiO₂ is provided on the surface thereof, which is then coated with a silane coupling agent. It is preferable for the thickness of the of the quartz substrate to be 0.3 mm or greater. If the thickness of the quartz substrate is less than 0.3 mm, it is likely to become damaged during handling or due to pressure during imprinting.

### (Pattern of Protrusions and Recesses)

The shape of the pattern 13 of protrusions and recesses is not particularly limited, and may be selected as appropriate according to the intended use of the nanoimprinting mold. An example of a typical pattern is a line and space pattern as illustrated in FIG. 12B. The length of the lines, the width of the lines, the distance (the width of spaces) among the lines, and the height of the lines from the bottoms of the recesses are set as appropriate in the line and space pattern. For example, the width of the lines is within a range from 10 nm to 100 nm, more preferably within a range from 20 nm to 70 nm, the distance among the lines is within a range from 10 nm to 500 nm, more preferably within a range from 20 nm to 100 nm, and the height of the lines (the depth of the spaces) is within a range from 10 nm to 500 nm, more preferably within a range from 30 nm to 100 nm.

### (Pressure Vessel)

The pressure vessel 110 is constituted by a vessel main body 111 and a lid 112. The vessel main body 111 is equipped with an introducing inlet through which gas from the gas introducing section 120 is introduced, and an exhausting outlet through which gas is exhausted by the gas exhausting section 130. The introducing inlet and the exhausting outlet are connected to the gas introducing section 120 and the exhausting section 130 respectively. The lid 112 is equipped with a glass window 113 that enables positioning and exposure to be performed in a state in which the lid 112 is closed. However, the glass window 113 is not necessary in cases that positioning and exposure are performed in a state in which the lid 112 is open.

### (Gas Introducing Means)

The gas introducing section 120 is constituted by: a gas introducing pipe 121; a valve 122; and a gas introducing source (not shown) connected to the other end of the gas introducing pipe 121, for example. The exhausting section 130 is constituted by: an exhausting pipe 131; a valve 132; and an exhausting pump (not shown), for example. Air and inert gases are examples of the gas to be introduced. Examples of inert gases include N₂; He; and Ar. In the first embodiment, the gas introducing section 120 and the exhausting section 130 function as the gas introducing means of the present invention.

### (Substrate Setting Stage and Substrate Support Member)

The setting stage 145 is for setting the substrate 7 to be processed on. The setting stage 145 is configured to be movable (including rotation in the present specification) in the x direction (the horizontal direction in FIG. 1), the y direction (the direction perpendicular to the drawing sheet in FIG. 1), the z direction (the vertical direction in FIG. 1), and the θ direction (a rotational direction having an axis in the z direction as the center of rotation) so as to enable positioning with respect to the pattern of protrusions and recesses on the mold 1. In addition, the setting stage 145 is equipped with a substrate supporting member 140 which is movable in the z direction. The substrate supporting member 140 is utilized when lifting the substrate 7, which is placed on the setting stage 145, up away from the setting stage 145, and also when supporting the assembly. The setting stage 145 may be configured with suctioning openings for suctioning and holding the substrate 7 and a heater for heating the substrate 7.

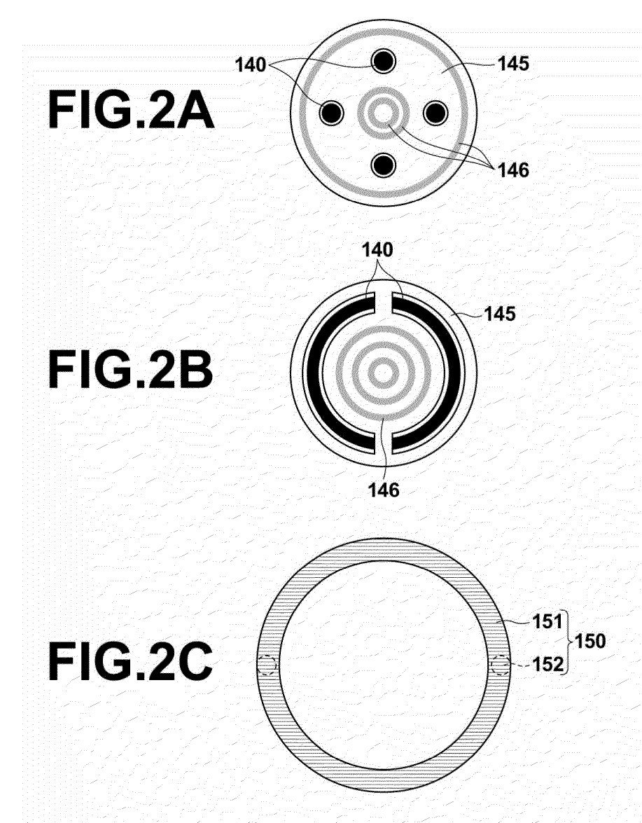

FIG. 2A is a diagram in plan view (a downward facing viewpoint in the z direction) that schematically illustrates a first embodiment of the setting stage 145 for the substrate 7. FIG. 2B is a diagram in plan view that schematically illustrates a second embodiment of the setting stage 145 for the substrate 7.

The setting stage 145 illustrated in FIG. 2A is equipped with a substrate supporting member 140 constituted by a plurality (4 in the present embodiment) dot shaped protrusions, and suctioning openings 146. It is preferable for the dot shaped protrusions to be configured such that the contact surface between them and the assembly 8 will be small, in order to enable the assembly 8 to be supported within the pressure vessel 110 such that fluid pressure of the environment operates on substantially the entire surface of the assembly 8. Specifically, the tips of the dot shaped protrusions may have radii of curvature such that the contact surfaces approximate points. This configuration is preferable because if the areas of the contact surfaces become large, external forces other than the fluid pressure are applied to the assembly 8 at these portions, and the assembly 8 may become more likely to deform. The number of dot shaped protrusions is not particularly limited, and 8 is preferable, 6 is more preferable, and 3 is most preferable. Meanwhile, the setting stage 145 illustrated in FIG. 2B is equipped with a substrate supporting member 140 constituted by linear protrusions that form a ring, and suctioning openings 146. In FIG. 2B, the substrate supporting member 140 is in the form of a broken ring shape. Alternatively, the substrate supporting member 140 may be in the form of a complete ring. It is preferable for the linear protrusions to be configured such that the contact surface between them and the assembly 8 will be small, in order to enable the assembly 8 to be supported within the pressure vessel 110 such that fluid pressure of the environment operates on substantially the entire surface of the assembly 8. In this case as well, the tips of the linear protrusions may have radii of curvature such that the contact surfaces approximate points. The number of linear protrusions need only be that which enables formation of a single annular shape.

It is preferable for the protrusions to be arranged such that they support portions of the assembly 8 other than the portion thereof corresponding to the pattern. For example, in the case of the substrate supporting member 140 illustrated in FIG. 2A, the substrate supporting member 140 constituted by the plurality of protrusions is arranged such that the assembly 8 is supported at portions other than the portion corresponding to the pattern, by arranging the plurality of protrusions at positions uniformly placed about the portion corresponding to the pattern. In the case of the substrate supporting member 140 illustrated in FIG. 2B, the ring shaped substrate supporting member 140 is arranged such that the assembly 8 is supported at portions other than the portion corresponding to the pattern by arranging the portion corresponding to the pattern within the interior of the annular shape. These configurations are adopted such that external forces other than the fluid pressure are not applied to the portion corresponding to the pattern.

### (Mold Supporting Member)

The mold supporting member 150 supports the mold 1 within the pressure vessel 110 to face the substrate 7 which is placed on the setting stage 145. FIG. 2C is a diagram in plan view that schematically illustrates a first embodiment of a mold supporting member 150. As illustrated in FIG. 2C, the mold supporting member 150 is constituted by a ring portion 151 and support columns 152. The ring portion 151 may be in the shape of a discontinuous ring.

### (Light Receiving Device)

The light receiving device 161 is utilized when positioning the pattern of protrusions and recesses with respect to the substrate 7 to be processed in a state in which the mold 1 is supported by the mold supporting member 150 and the substrate 7 which is coated with photocurable resin 6 is set on the setting stage 145. That is, the setting stage 145, which is movable in the x, y, z, and θ directions, is adjusted while observing the pattern 13 of protrusions and recesses with the light receiving device 161 with the lid open 112 or through the glass window 113. The light receiving device 161 is also configured to be movable in the x, y, z, and θ directions, from the viewpoint of operability of the apparatus. An optical microscope having a built in CCD may be utilized as the light receiving device 161. An example of such an optical microscope is a digital microscope (VH-5500 Series) by K. K. KEYENCE.

### (Exposure Light Source)

The exposure light source 162 is utilized to expose the photocurable resist 6. The exposure light source 162 is also configured to be movable in the x, y, z, and θ directions, from the viewpoint of operability of the apparatus. A light source that emits light having a wavelength within a range from 300 nm to 700 nm produced by Sen Lights Corporation, for example, may be employed as the exposure light source 162.

### (Nanoimprinting Method)

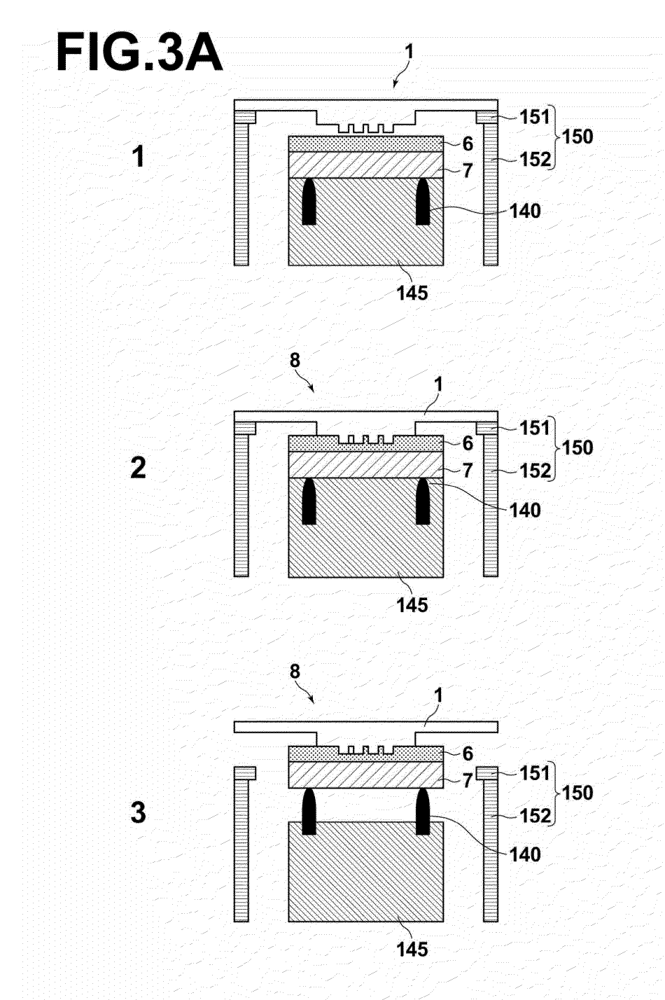

FIGS. 3A and 3B are collections of sectional diagrams that schematically illustrate the steps of a nanoimprinting method according to a first embodiment of the present invention. In order to facilitate understanding of the drive procedures of the apparatus, only the setting stage 145, the mold supporting member 150, and elements necessary to explain the procedures employing these components are illustrated in FIGS. 3A and 3B.

The nanoimprinting method of the first embodiment is executed as follows. First, the lid 112 of the pressure vessel 110 is opened, the substrate 7 to be processed, a surface of which is coated with the photocurable resin 6, is set on the setting stage 145, and the mold 1 is placed on the mold supporting member 150 such that the pattern 13 of protrusions and recesses faces the photocurable resin 6 (1 of FIG. 3A). Then, the pattern of protrusions and recesses is positioned with respect to the substrate 7 using the light receiving device 161. Next, the lid 112 of the pressure vessel 110 is closed, and the interior of the pressure vessel 110 is exhausted by the exhausting section 130. At this time, He may be introduced into the pressure vessel 110 after the lid 112 is closed. Then, the setting stage 145 is moved upward in the z direction until the photocurable resin 6 comes into contact with the pattern 13 of protrusions and recesses, to form the assembly 8 constituted by the mold 1, the photocurable resin 6, and the substrate 7 (2 of FIG. 3A). At this time, the pattern 13 of protrusions and recesses is not completely filled by the photocurable resin 6, and portions thereof have unfilled locations. In addition, the assembly 8 at this time is in a state in which the mold 1, the photocurable resin 6, and the substrate 7 are merely assembled together, and therefore the entirety of the surface thereof is directly exposable to the environment. Thereafter, the substrate supporting member 140 is moved to lift the assembly 8 further upward in the z direction (3 of FIG. 3A). Thereby, the mold 1 is separated from the mold supporting member 150, and the assembly 8 is in a state in which it is supported only by the substrate supporting member 140. The substrate supporting member 140 is constituted only by four dot shaped protrusions, and the contact areas between the protrusions and the assembly 8 are extremely small. Therefore, the assembly 8 is supported such that fluid pressure of the environment operates on substantially the entire surface thereof. Gas is introduced by the gas introducing section 120 while the assembly 8 is supported such that fluid pressure of the environment operates on substantially the entire surface thereof. As a result, the mold 1 and the substrate 7 to be processed are pressed against each other by the fluid pressure exerted by the gas, and the photocurable resin 6 completely fills the pattern of protrusions and recesses (1 of FIG. 3B). Then, ultraviolet light is irradiated onto the photocurable resin 6 within the assembly 8, to cure the photocurable resin 6. After transfer to and exposure of the photocurable resin 6 are completed, the substrate supporting member 140 is housed in the setting stage 145 (2 of FIG. 3B). At this time, the assembly 8 is supported by the mold supporting member 150 and the setting stage 145. Next, the bottom surface of the substrate 7 (the surface opposite the surface coated with the photocurable resin 6) is suctioned and fixed onto the setting stage 145. Finally, the setting stage 145 is moved downward in the z direction while suctioning the substrate 7, to separate the mold 1 and the cured photocurable resin 6 (3 of FIG. 3B).

### (Curable Resin)

The photocurable resin 6 is not particularly limited. In the present embodiment, a photocuring resin prepared by adding a photopolymerization initiator (approximately 2% by mass) and a fluorine monomer (0.1% to 1% by mass) to a polymerizable compound may be employed. An antioxidant (approximately 1% by mass) may also be added as necessary. The photocuring resin produced by the above procedures can be cured by ultraviolet light having a wavelength of 360 nm. With respect to resins having poor solubility, it is preferable to add a small amount of acetone or acetic ether to dissolve the resin, and then to remove the solvent.

Examples of the polymerizable compound include: benzyl acrylate (Viscoat #160 by Osaka Organic Chemical Industries, K.K.), ethyl carbitol acrylate (Viscoat #190 by Osaka Organic Chemical Industries, K.K.), polypropylene glycol diacrylate (Aronix M-220 by TOAGOSEI K.K.), and trimethylol propane PO denatured triacrylate (Aronix M-310 by TOAGOSEI K.K.). In addition, a compound A represented by the following chemical formula (1) may also be employed as the polymerizable compound.

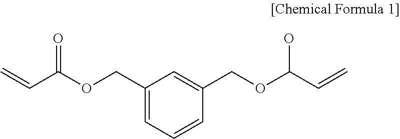 [SMILES: C=CC(=O)OCc1cccc(COC(O)C=C)c1]

Examples of the photopolymerization initiating agent include alkyl phenone type photopolymerization initiating agents, such as 2-(dimethyl amino)-2-[(4-methylphenyl) methyl]-1-[4- (4-morpholinyl) phenyl]-1-butanone (IRGACURE 379 by Toyotsu Chemiplas K.K.)

In addition, a compound B represented by the following chemical formula (2) may be employed as the fluorine monomer.

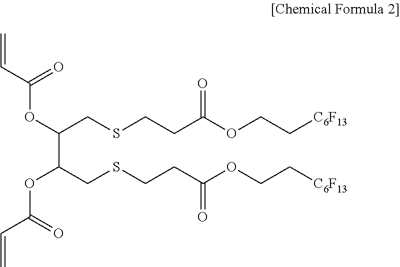

In the case that the photocurable resin is coated by the ink jet method, it is preferable for a photocurable resin formed by mixing the compound represented by Chemical Formula (1), Aronix M-220, Irgacure 379, and the fluorine monomer represented by Chemical Formula (2) at a ratio of 48:48:3:1 to be utilized. On the other hand, in the case that the photocurable resin is coated by the spin coat method, it is preferable for a polymerizable compound diluted to 1% by mass with PGMEA (Propylene Glycol Methyl Ether Acetate) to be utilized as the photocurable resin.

### (Method for Coating Curable Resin)

Coating of the photocurable resin 6 may be executed by utilizing the spin coat method, the dip coat method, the ink jet method, etc. In addition, it is preferable for the thickness of the coated photocurable resin 6 to be greater than or equal to differences in the surface height of the substrate 7. By setting the thickness of the coated photocurable resin 6 to be greater than or equal to differences in the surface height of the substrate 7, residual gas becomes less likely to remain after nanoimprinting is executed. Thereby, defects caused by the photocurable resin 6 not filling the pattern 13 of protrusions and recesses (incomplete filling defects) become less likely to occur. Note that the “thickness of the coated photocurable resin” refers to the thickness of a film when coated in the case that the photocurable resin is coated uniformly in the form of a film by the spin coat method, the dip coat method, etc. In the case that the photocurable resin is coated in the form of droplets as in the ink jet method, for example, the “thickness of the coated photocurable resin” refers to the height of the droplets when coated. The thickness of the photocurable resin is within a range from 6 nm to 10 μm, more preferably within a range from 10 nm to 1 μm, and most preferably within a range from 15 nm to 100 nm. The lower limit of the thickness is set to 6 nm because the differences in surface height of substrates having superior planarity is approximately 6 nm, and it is necessary for the thickness of the photocurable resin to be greater than or equal to this value. Meanwhile, the upper limit is set to 10 μm because in the case that a pattern of protrusions and recesses having spaces with widths of 200 nm or less is formed by nanoimprinting, the residual film of the pattern formed on the photocurable resin will become excessively thick if the coated layer of the photocurable resin is greater than 10 μm. In such a case, it will become difficult to form a pattern of protrusions and recesses corresponding to the pattern on the photocurable resin on the surface of the substrate on which the photocurable resin is coated.

The expression “differences in the surface height of the substrate” refers to relative differences in heights between high portions and low portions of the substrate due to undulations in the surface thereof. A “3σ value related to a height difference distribution” is employed as an index for the differences in the surface height of the substrate. The expression “height difference distribution” refers to a distribution of differences in height using an average value of the heights of the surface as a standard. The “3σ value” refers to the absolute values of values within a range of ±3σ from the average value when the height difference distribution is caused to approximate a Gaussian distribution. Here, σ is a standard deviation within a Gaussian distribution. The “3σ value related to a height difference distribution” may be obtained by measuring the surface of the substrate (the surface to be coated with the photocurable resin in the present embodiment) with NewView 6300 by ZYGO.

It is preferable for the 3σ value to be calculated after the surface shape is measured for at least a 30 mm square range. Here, the measurement range is more preferably 40 mm square, and most preferably 50 mm square. These measurement ranges are preferred because evaluations of fluctuations in the thickness of the photocurable resin film and of incomplete filling defects within a range corresponding to the entire region of a single semiconductor chip will be more reliable, taking the fact that a common size of a single semiconductor chip is 26 mm·33 mm.

In the case that the photocurable resin 6 is coated by the ink jet method, it is preferable for a piezoelectric type of ink jet head, in which the amount of photocuring resin in each coated droplet and the expulsion speed are adjustable, to be employed. The amount of photocuring resin in each coated droplet and the expulsion speed are set and adjusted prior to arranging the droplets of photocurable resin onto the substrate. For example, it is preferable for the amount of photocurable resin in each coated droplet to be adjusted to be greater at regions at which the spatial volume of the recesses of the pattern of protrusions and recesses is large, and to be smaller at regions at which the spatial volume of the recesses of the pattern of protrusions and recesses is small. Such adjustments are controlled as appropriate according to the amount of photocurable resin expelled in each droplet.

(Pressure within Pressure Vessel)

It is preferable for the pressure vessel 110 to be filled with gas such that the pressure within the pressure vessel is within a range from 0.1 MPa to 5 MPa, more preferably within a range from 0.5 MPa to 3 MPa, and most preferably within a range from 1 MPa to 2 MPa. The lower limit of the pressure is set to 0.1 MPa because if the pressure is less than 0.1 MPa, incomplete filling defects will occur due to residual gas not being pushed out of a patterned region R1, residual gas not passing through a quartz substrate (in the case that the gas is He), or residual gas not dissolving in the photocurable resin 6. In addition, if the pressure is less than 0.1 MPa, the substrate 7 to be processed will not yield to the fluid pressure, and fluctuations in residual film will be likely to occur. On the other hand, the upper limit is set to 5 MPa because if the pressure is greater than 5 MPa, there is a possibility that the mold 1 and the substrate 7 will be damaged if a foreign object is interposed therebetween.

### (Mold Release Step)

It is preferable for the mold 1 and the substrate 7 to be separated while the assembly 8 is heated by a heating means (not shown). The temperature Tr (° C.) to which the assembly 8 is heated is set such that it satisfies the inequality Tp−5<Tr<{(Tp+20) or Tg, whichever is smaller}, more preferably such that it satisfies the inequality Tp−3<Tr<{(Tp+15) or Tg, whichever is smaller}, and most preferably such that it satisfies the inequality Tp−1<Tr<{(Tp+10) or Tg, whichever is smaller}. Note that in the above inequalities, Tp is the maximum temperature (generally within a range of approximately 25° C. to 50° C.) of the assembly 8 when fluid pressure is being applied, and Tg is the glass transition temperature (° C.) of the curable resin. The temperature Tr is set to be within these ranges for the following reasons. The temperature within the pressure vessel 110 increases due to adiabatic compression when the mold 1 and the substrate 7 coated with the curable resin are pressed against each other by fluid pressure. The temperature of the assembly 8 also rises accompanying this increase in temperature. In addition, the temperature of the assembly 8 also rises during exposure with ultraviolet light. However, because the mold release process is performed at atmospheric pressure or at a reduced pressure, the temperature within the pressure vessel 110 is lower than during the pressing process. At this time, if the temperature Tr is lower than Tp−5° C. or greater than Tp+20° C., defects due to the curable resin peeling (peeling defects) will be generated due to the mold 1, the curable resin, and the substrate 7 undergoing thermal contraction or thermal expansion. In addition, if the temperature Tr is higher than the glass transition temperature of the curable resin, the shape of the pattern on the curable resin will deform during the mold release process. Accordingly, it is preferable for the temperature of the mold 1, the curable resin, and the substrate 7 to be as close to that during the pressing process under fluid pressure, in order to suppress the influence of thermal contraction, thermal expansion, and thermal deformation. Heating of the assembly 8 may be executed by an electric heater, a halogen heater, etc. provided within or in the vicinity of the setting stage 145.

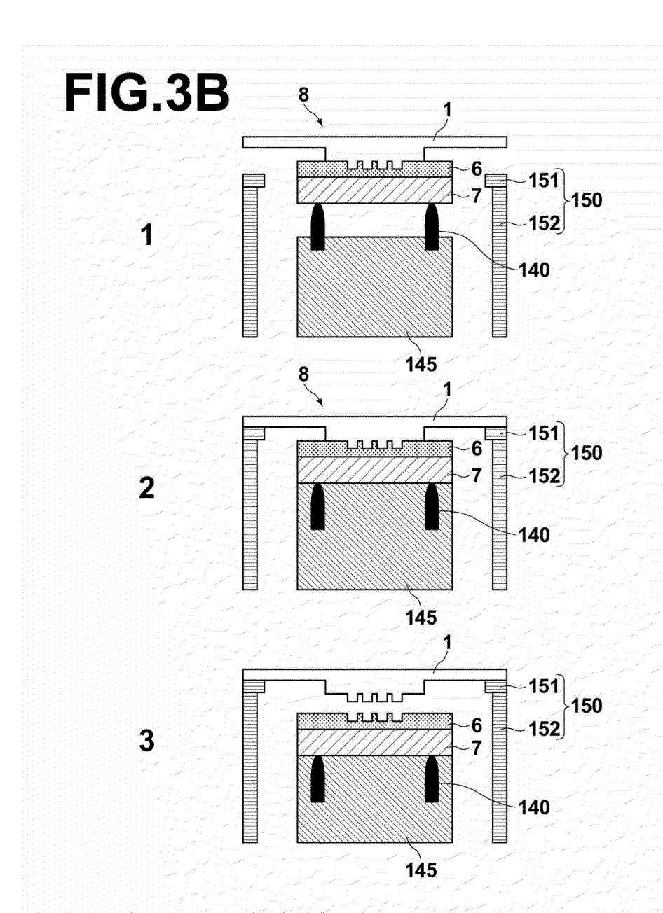

FIG. 4 is a sectional diagram that schematically illustrates the manner in which fluid pressure P1 and P2 operate on the assembly 8 within the pressure vessel 110, which is filled with gas, at the step illustrated in 1 of FIG. 3A. In FIG. 4, P1 denotes fluid pressure which is applied onto the surface of the mold 1, and P2 denotes fluid pressure which is applied onto the surface of the substrate 7 and the surface of the curable resin. As illustrated in FIG. 4, the entirety of the surface of the assembly 8 is directly exposable to the environment at the step illustrated in 1 of FIG. 3A. In addition, the assembly 8 is supported by the substrate supporting member 140 constituted by the dot shaped protrusions such that fluid pressure of the environment operates on substantially the entire surface of the assembly 8. That is, uniform fluid pressure P1 is applied to the surface of the assembly 8, and particularly a flange portion 15 of the mold 1, and uniform fluid pressure P2 is applied to the portion of the substrate 7 that faces the flange portion 15. Thereby, bending of the mesa type mold 1 is prevented. In addition, the substrate supporting member 140 supports the assembly 8 at portions other than a portion 8a corresponding to the pattern. Thereby, external forces other than the fluid pressure P1 and the fluid pressure P2 being applied to the portion 8a corresponding to the pattern is prevented.

As described above, the nanoimprinting method of the present invention introduces gas into the pressure vessel while supporting the assembly, of which the entire surface is directly exposable to the environment, with a support member within the pressure vessel such that fluid pressure of the environment operates on substantially the entire surface of the assembly. The fluid pressure of the gas presses the mold and the substrate against each other. By adopting this configuration, uniform fluid pressure is applied to a flange portion of the mold and a portion of the substrate that faces the flange portion. Thereby, bending of the mold and the substrate can be prevented. Pressing of a mold against a surface coated with curable resin at a uniform pressure is realized in nanoimprinting that employs a mesa type mold and/or a mesa type substrate, and it becomes possible to suppress the generation of fluctuations in residual film.

In addition, the nanoimprinting apparatus of the present invention is characterized by being equipped with: a pressure vessel, for housing an assembly constituted by a mold having a fine pattern of protrusions and recesses on the surface thereof, and a substrate having a surface coated with curable resin, formed by placing the pattern of protrusions and recesses and the cured resin coated on the surface of the substrate in contact with each other, filled with a gas; a support member provided within the pressure vessel, for supporting the assembly, of which the entire surface is directly exposable to the environment such that fluid pressure of the environment operates on substantially the entire surface of the assembly; and a gas introducing means, for introducing a gas into the pressure vessel. Accordingly, the nanoimprinting apparatus of the present invention is capable of executing the nanoimprinting method of the present invention. Pressing of a mold against a surface coated with curable resin at a uniform pressure is realized in nanoimprinting that employs a mesa type mold and/or a mesa type substrate, and it becomes possible to suppress the generation of fluctuations in residual film.

### Design Modifications to the First Embodiment

In the first embodiment, a case was described in which only the mold has a mesa portion. The nanoimprinting method and the nanoimprinting apparatus of the present invention may also be applied in cases that only the substrate has a mesa portion or both the substrate and the mold has mesa portions.

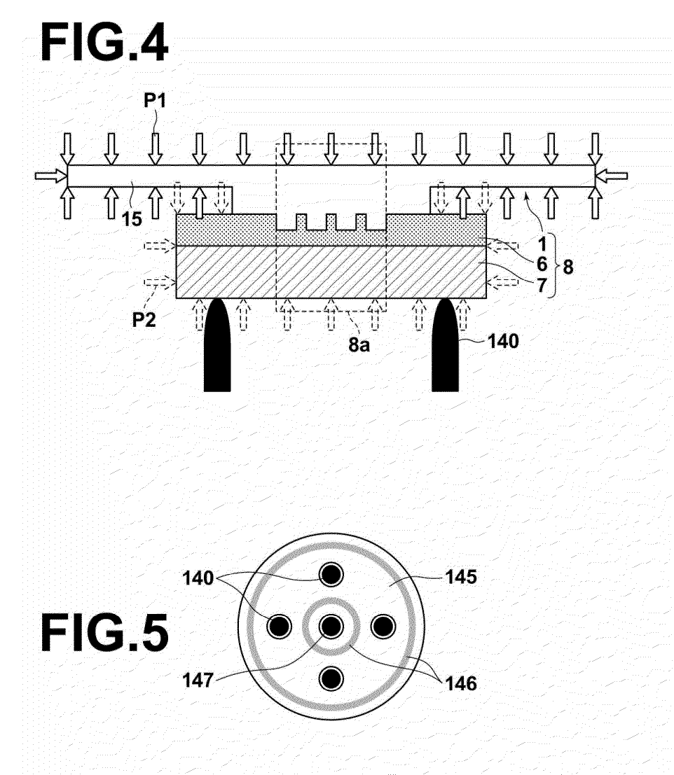

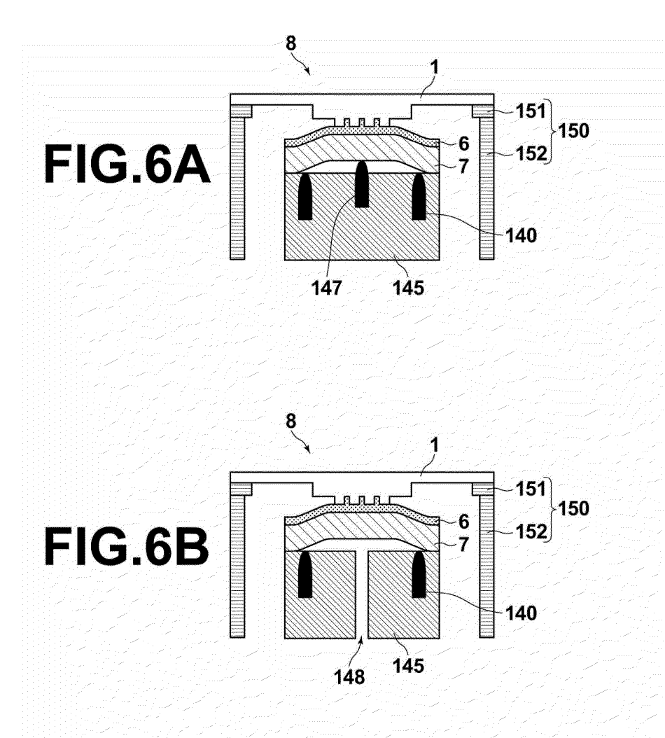

In addition, the mold 1 and the photocurable resin 6 were placed in contact while moving the substrate 7 to be processed with the setting stage 145 in the first embodiment. Alternatively, a configuration may be adopted wherein a pin 147 for pressing the central portion of the substrate 7 during contact is provided at the central portion of the setting stage 145, as illustrated in FIG. 5 and FIG. 6A. The mold 1 and the photocurable resin 6 are caused to contact each other by pressing the central portion of the substrate against the mold 1 with the pin 147 while the outer periphery of the substrate 7 is suctioned. Note that the pin 147 is retracted when gas is introduced into the pressure vessel 110 to cause fluid pressure to operate on the assembly 8. As another means for pressing the central portion of the substrate 7 against the mold 1 during contact, a second gas introducing section 148 may be provided in the central portion of the setting stage 145, as illustrated in FIG. 6B. In this case, gas introduced through the second gas introducing section 148 is blown onto the substrate 7.

Further, the mold 1 and the substrate 7 to be processed were respectively placed on the mold supporting member 150 and the setting stage 145 in the first embodiment. Alternatively, the mold 1 and the substrate 7 coated with the photocurable resin 6 may be placed in contact, that is, form the assembly 8, and then placed on the setting stage 145 in this state.

### Second Embodiment

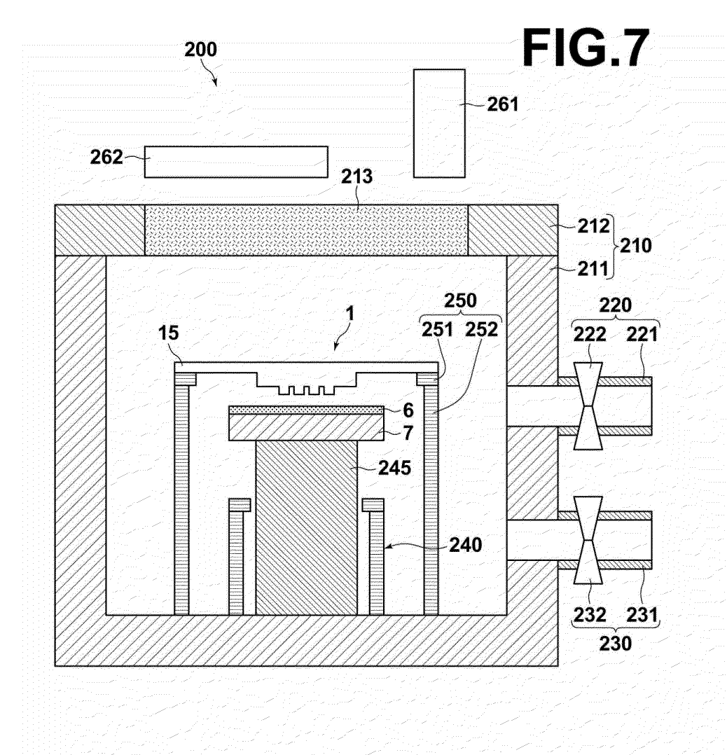

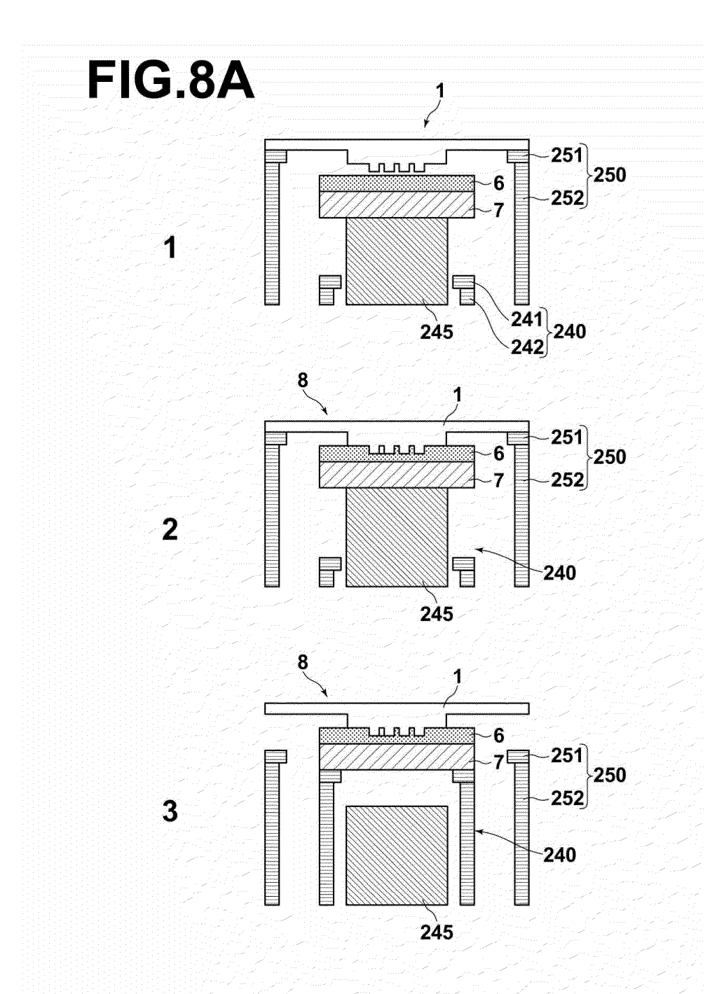

A second embodiment of the nanoimprinting method and the nanoimprinting apparatus of the present invention will be described with reference to FIGS. 7 through 8B. FIG. 7 is a sectional diagram that schematically illustrates the nanoimprinting apparatus according to the second embodiment of the present invention. FIG. 8A and FIG. 8B are collections of sectional diagrams that schematically illustrate the steps of the nanoimprinting method according to the second embodiment of the present invention. Note that configurations of a setting stage for a substrate and a substrate supporting member of the second embodiment differ from those of the first embodiment. Accordingly, detailed descriptions of elements which are the same as those of the first embodiment will be omitted insofar as they are not particularly necessary.

### (Nanoimprinting Apparatus)

First, a nanoimprinting apparatus for executing the nanoimprinting method according to the second embodiment will be described. The nanoimprinting method of the second embodiment is executing employing a nanoimprinting apparatus 200 illustrated in FIG. 7. The nanoimprinting apparatus 200 of FIG. 7 is equipped with: a pressure vessel 210; a gas introducing section 220 that introduces gas into the pressure vessel 210; an exhaust section 230 for exhausting gas from the interior of the pressure vessel 210; a substrate supporting member 240 for supporting a substrate 7 to be processed; a substrate setting stage 245 on which the substrate 7 is set; a mold supporting member 250 for supporting a mold 1; a light receiving device 261 for positioning a pattern of protrusions and recesses; and an exposure light source 262 for exposing photocurable resin. Note that in FIG. 7, reference numeral 211 denotes a container main body of the pressure vessel 210, reference numeral 212 denotes a lid of the pressure vessel 210, reference numeral 213 denotes a glass window of the lid, reference number 221 denotes a gas introducing pipe of the gas introducing section 220, reference numeral 222 denotes a valve of the gas introducing section 220, reference numeral 231 denotes an exhaust pipe of the exhaust section 230, reference numeral 232 denotes a valve of the exhaust section 230, reference numeral 251 denotes a ring portion of the mold supporting member 250, and reference numeral 252 denotes a support column portion of the mold supporting member.

### (Substrate Setting Stage)

The setting stage 245 is for setting the substrate 7 to be processed on. The setting stage 245 is configured to be movable in the x direction (the horizontal direction in FIG. 7), the y direction (the direction perpendicular to the drawing sheet in FIG. 7), the z direction (the vertical direction in FIG. 7), and the θ direction (a rotational direction having an axis in the z direction as the center of rotation) so as to enable positioning with respect to the pattern of protrusions and recesses on the mold 1. The setting stage 245 may be configured with suctioning openings for suctioning and holding the substrate 7 and a heater for heating the substrate 7.

### (Substrate Supporting Member)

The substrate supporting member 240 is utilized when lifting the substrate 7, which is placed on the setting stage 245, up away from the setting stage 245, and also when supporting an assembly 8. The substrate supporting member 240 is configured to be movable at least in the z direction, similar to the setting stage 245. The substrate supporting member 240 of the second embodiment is constituted by a ring portion 241 and support columns 242 similar to the mold supporting member 250, as illustrated in FIG. 7 and FIG. 8A. The ring portion 241 may be in the form of a broken ring shape.

### (Nanoimprinting Method)

In order to facilitate understanding of the drive procedures of the apparatus, only the setting stage 245, the substrate supporting member 240, the mold supporting member 250, and elements necessary to explain the procedures employing these components are illustrated in FIGS. 8A and 8B.

The nanoimprinting method of the second embodiment is executed as follows. First, a lid 212 of the pressure vessel 210 is opened, the substrate 7 to be processed, a surface of which is coated with photocurable resin 6, is set on the setting stage 245, and the mold 1 is placed on the mold supporting member 250 such that a pattern of protrusions and recesses faces the photocurable resin 6 (1 of FIG. 8A). Then, the pattern of protrusions and recesses is positioned with respect to the substrate 7 using the light receiving device 261. Next, the lid 212 of the pressure vessel 210 is closed, and the interior of the pressure vessel 210 is exhausted by the exhausting section 230. At this time, He may be introduced into the pressure vessel 210 after the lid 212 is closed. Then, the setting stage 245 is moved upward in the z direction until the photocurable resin 6 comes into contact with the pattern 13 of protrusions and recesses of the mold 1, to form the assembly 8 constituted by the mold 1, the photocurable resin 6, and the substrate 7 (2 of FIG. 8A). At this time, the pattern 13 of protrusions and recesses is not completely filled by the photocurable resin 6, and portions thereof have unfilled locations. In addition, the assembly 8 at this time is in a state in which the mold 1, the photocurable resin 6, and the substrate 7 are merely assembled together, and therefore the entirety of the surface thereof is directly exposable to the environment. Thereafter, the substrate supporting member 240 is moved to lift the assembly 8 further upward in the z direction (3 of FIG. 8A). Thereby, the mold 1 is separated from the mold supporting member 250, and the assembly 8 is in a state in which it is supported only by the substrate supporting member 240. The substrate supporting member 240 is constituted by the ring portion 241 and the support columns 242, and the contact area between the ring portion 241 and the assembly 8 is an extremely small area at the outer periphery of the assembly 8. Therefore, the assembly 8 is supported such that fluid pressure of the environment operates on substantially the entire surface thereof. Gas is introduced by the gas introducing section 220 while the assembly 8 is supported such that fluid pressure of the environment operates on substantially the entire surface thereof. As a result, the mold 1 and the substrate 7 to be processed are pressed against each other by the fluid pressure exerted by the gas, and the photocurable resin 6 completely fills the pattern of protrusions and recesses (1 of FIG. 8B). Then, ultraviolet light is irradiated onto the photocurable resin 6 within the assembly 8, to cure the photocurable resin 6. After transfer to and exposure of the photocurable resin 6 are completed, the substrate supporting member 240 is moved downward in the z direction and returned to its original position (2 of FIG. 8B). At this time, the assembly 8 is supported by the mold supporting member 250 and the setting stage 245. Thereafter, the mold 1 and the cured photocurable resin 6 are separated in the same manner as in the first embodiment.

As described above, the nanoimprinting method of the second embodiment also introduces gas into the pressure vessel while supporting the assembly, of which the entire surface is directly exposable to the environment, with a support member within the pressure vessel such that fluid pressure of the environment operates on substantially the entire surface of the assembly. The fluid pressure of the gas presses the mold and the substrate against each other. Therefore, the same advantageous effects as those obtained by the nanoimprinting method of the first embodiment can be obtained.

In addition, the nanoimprinting apparatus of the second embodiment is characterized by being equipped with: a pressure vessel, for housing an assembly constituted by a mold having a fine pattern of protrusions and recesses on the surface thereof, and a substrate having a surface coated with curable resin, formed by placing the pattern of protrusions and recesses and the cured resin coated on the surface of the substrate in contact with each other, filled with a gas; a support member provided within the pressure vessel, for supporting the assembly, of which the entire surface is directly exposable to the environment such that fluid pressure of the environment operates on substantially the entire surface of the assembly; and a gas introducing means, for introducing a gas into the pressure vessel. Therefore, the same advantageous effects as those obtained by the nanoimprinting apparatus of the first embodiment can be obtained.

### Third Embodiment

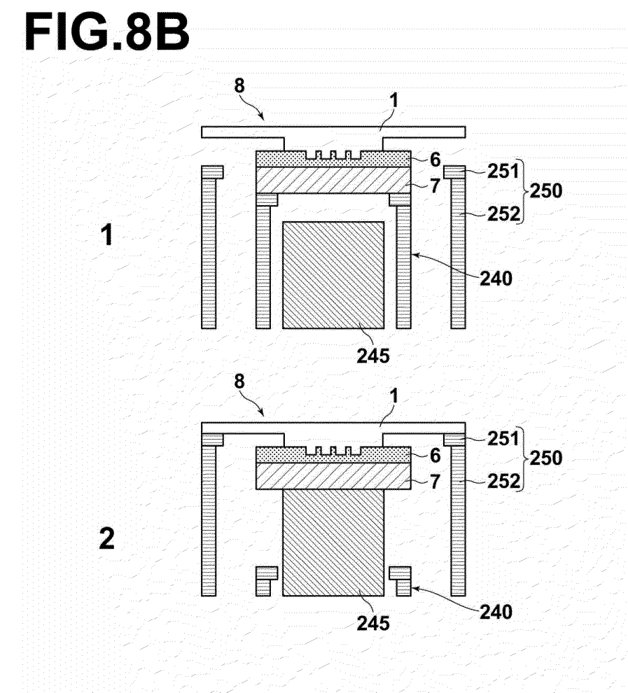

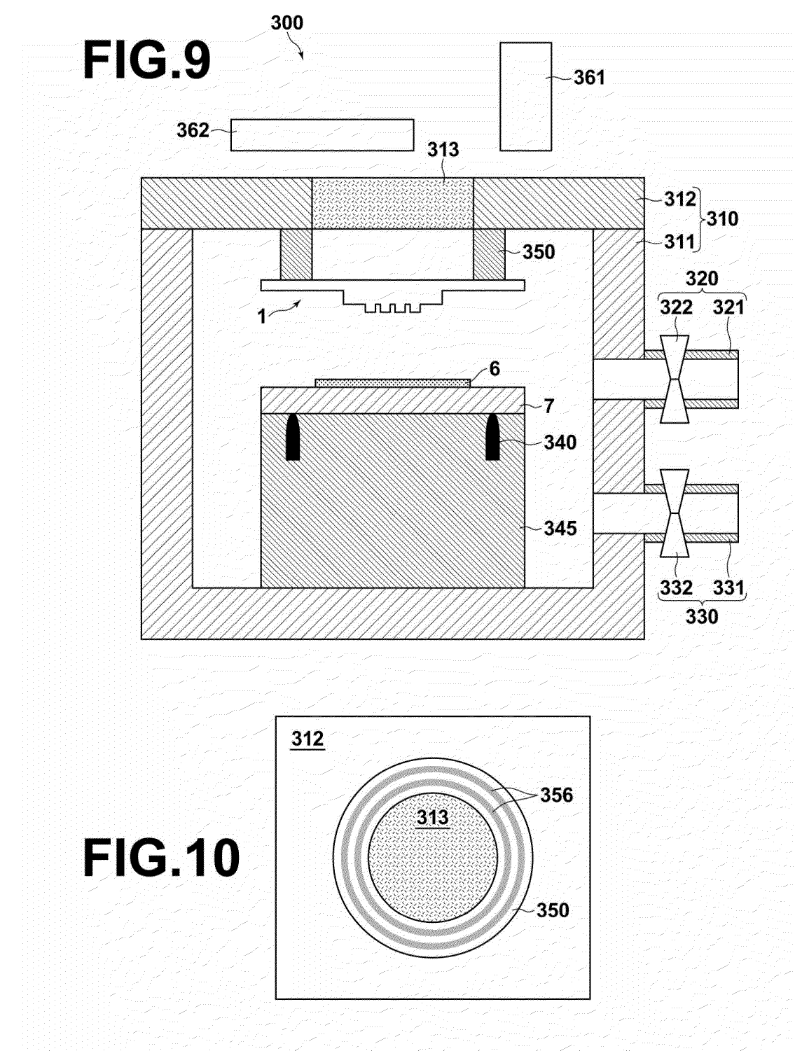

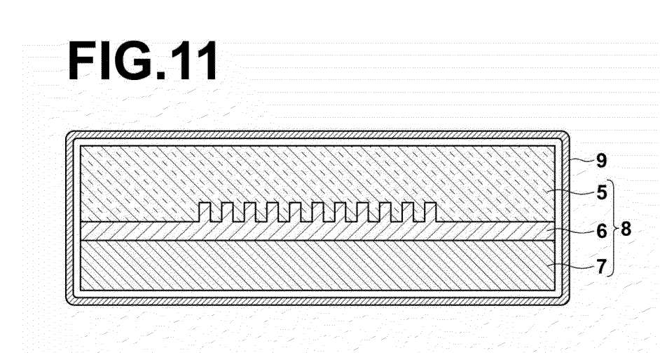

A third embodiment of the nanoimprinting method and the nanoimprinting apparatus of the present invention will be described with reference to FIG. 9 and FIG. 10. FIG. 9 is a sectional diagram that schematically illustrates the nanoimprinting apparatus according to the third embodiment of the present invention. FIG. 10 is a diagram in bottom view that schematically illustrates a mold supporting member for a mold of the nanoimprinting apparatus of the third embodiment. Note that configuration of the mold supporting member of the third embodiment differs from that of the first embodiment. Accordingly, detailed descriptions of elements which are the same as those of the first embodiment will be omitted insofar as they are not particularly necessary.

### (Nanoimprinting Apparatus)

First, a nanoimprinting apparatus for executing the nanoimprinting method according to the third embodiment will be described. The nanoimprinting method of the second embodiment is executing employing a nanoimprinting apparatus 300 illustrated in FIG. 9. The nanoimprinting apparatus 300 of FIG. 9 is equipped with: a pressure vessel 310; a gas introducing section 320 that introduces gas into the pressure vessel 310; an exhaust section 330 for exhausting gas from the interior of the pressure vessel 310; a substrate setting stage 345 on which a substrate 7 is set; a substrate supporting member 340 for supporting the substrate 7 to be processed, provided in the setting stage 345; a mold supporting member 350 for supporting a mold 1; a light receiving device 361 for positioning a pattern of protrusions and recesses; and an exposure light source 362 for exposing photocurable resin. Note that in FIG. 9, reference numeral 311 denotes a container main body of the pressure vessel 310, reference numeral 312 denotes a lid of the pressure vessel 310, reference numeral 313 denotes a glass window of the lid, reference number 321 denotes a gas introducing pipe of the gas introducing section 320, reference numeral 322 denotes a valve of the gas introducing section 320, reference numeral 331 denotes an exhaust pipe of the exhaust section 330, reference numeral and 332 denotes a valve of the exhaust section 330.

### (Mold Supporting Member)

As illustrated in FIG. 10, the mold supporting member 350 has suctioning openings 356, and holds the mold 1 by suctioning the back surface (the surface of a supporting portion 11 on which a mesa portion 12 is not farmed) such that a pattern 13 of protrusions and recesses faces photocurable resin 6 coated on the substrate 7. The mold supporting member 350 is mounted to a lid 312 of the pressure vessel 310. In addition, the mold supporting member 350 is of an annular shape so as to enable exposure without opening the lid 312. The inner circumference of the annular shape has a diameter at least greater than a patterned region R1 of the mold 1. in addition, a glass window 313 is provided at a region within the inner circumference of the mold supporting member 350 as illustrated in FIG. 9 and FIG. 10. Exposure is executed through the glass window 313.

### (Nanoimprinting Method)

The nanoimprinting method of the second embodiment is executed as follows. First, the lid 312 of the pressure vessel 310 is opened, the substrate 7 to be processed, a surface of which is coated with photocurable resin 6, is set on the setting stage 345, and the mold 1 is suctioned by the mold supporting member 350, and the lid 312 is closed. Then, the pattern 13 of protrusions and recesses is positioned with respect to the substrate 7 using the light receiving device 361. Next, the interior of the pressure vessel 310 is exhausted by the exhausting section 330. At this time, He may be introduced into the pressure vessel 310 after the lid 312 is closed. Then, the setting stage 345 is moved upward in the z direction until the photocurable resin 6 comes into contact with the pattern 13 of protrusions and recesses of the mold 1, to form the assembly 8 constituted by the mold 1, the photocurable resin 6, and the substrate 7. After the assembly 8 is formed, suctioning of the mold 1 is ceased, and the setting stage 345 moves downward in the z direction. At this stage, the assembly 8 is supported by the setting stage 345. At this time, the pattern 13 of protrusions and recesses is not completely filled by the photocurable resin 6, and portions thereof have unfilled locations. In addition, the assembly 8 at this time is in a state in which the mold 1, the photocurable resin 6, and the substrate 7 are merely assembled together, and therefore the entirety of the surface thereof is directly exposable to the environment. In addition, the mold 1 is separated from the mold supporting member 350, and the assembly is supported only by the substrate supporting member 340. The substrate supporting member 340 is constituted only by four dot shaped protrusions, and the contact areas between the protrusions and the assembly 8 are extremely small. Therefore, the assembly 8 is supported such that fluid pressure of the environment operates on substantially the entire surface thereof. Gas is introduced by the gas introducing section 320 while the assembly 8 is supported such that fluid pressure of the environment operates on substantially the entire surface thereof. As a result, the mold 1 and the substrate 7 to be processed are pressed against each other by the fluid pressure exerted by the gas, and the photocurable resin 6 completely fills the pattern of protrusions and recesses. Then, ultraviolet light is irradiated onto the photocurable resin 6 within the assembly 8, to cure the photocurable resin 6. After transfer to and exposure of the photocurable resin 6 are completed, the substrate supporting member 340 is housed in the setting stage 345. Then, the setting stage 345 is moved upward in the z direction until the assembly 8 comes into contact with the mold supporting member 350. Thereafter, the underside of the substrate 7 is suctioned by the setting stage 345, and the upper surface of the mold 1 is suctioned by the mold supporting member 350. Finally, the setting stage 345 is moved downward in the z direction while suctioning the mold 1 and the substrate 7, to separate the mold 1 and the cured curable resin 6 from each other.

The nanoimprinting method and the nanoimprinting apparatus of the third embodiment is useful in cases that the substrate 7 to be processed is larger than the mold 1.

As described above, the nanoimprinting method of the third embodiment also introduces gas into the pressure vessel while supporting the assembly, of which the entire surface is directly exposable to the environment, with a support member within the pressure vessel such that fluid pressure of the environment operates on substantially the entire surface of the assembly. The fluid pressure of the gas presses the mold and the substrate against each other. Therefore, the same advantageous effects as those obtained by the nanoimprinting method of the first embodiment can be obtained.

In addition, the nanoimprinting apparatus of the third embodiment is characterized by being equipped with: a pressure vessel, for housing an assembly constituted by a mold having a fine pattern of protrusions and recesses on the surface thereof, and a substrate having a surface coated with curable resin, formed by placing the pattern of protrusions and recesses and the cured resin coated on the surface of the substrate in contact with each other, filled with a gas; a support member provided within the pressure vessel, for supporting the assembly, of which the entire surface is directly exposable to the environment such that fluid pressure of the environment operates on substantially the entire surface of the assembly; and a gas introducing means, for introducing a gas into the pressure vessel. Therefore, the same advantageous effects as those obtained by the nanoimprinting apparatus of the first embodiment can be obtained.

### EXAMPLES

Examples of the nanoimprinting method of the present invention will be described below.

### Example

Photocurable resin was coated on a quartz substrate (surface height difference=30nm) having a diameter of 4 inches, to coat the quartz substrate with a photocurable resin layer having a thickness of 60 nm. A mold having a mesa portion was produced based on a quartz substrate having a diameter of 6 inches. A line and space pattern is formed on the surface of the mesa portion by a plurality of spaces having a depth of 100 nm. The widths of the space patterns and the distances among spaces (widths of the lines) were 100 nm and 100 nm, respectively. A mold release process was administered on the quartz mold. The nanoimprinting apparatus of the third embodiment was utilized as a nanoimprinting apparatus. First, the quartz substrate on which the photocurable resin layer was formed was set on the setting stage, and the mold was suctioned and held by the mold supporting member such that the line and space pattern faced the photocurable rein layer. Thereafter, the mold was caused to lightly contact the photocurable resin layer, to form an assembly. Then, the assembly was lifted by the substrate supporting member, to support the assembly such that fluid pressure of the environment directly operates on substantially the entire surface of the assembly. Next, air was introduced into the pressure vessel such that the pressure therein became 1 MPa. The mold was pressed into the photocurable resin layer due to the fluid pressure exerted by the air. Then, the photocurable resin layer was exposed. At this time, the temperature of the surface of the substrate was 45° C. Pressure was reduced to atmospheric pressure, the setting stage within the pressure vessel was heated until the temperature of the surface of the substrate reached 50° C., then the mold and the cured curable resin were separated. Details regarding the photocurable resin, the quartz substrate, the apparatus, and each of the steps are as follows.

### (Photocurable Resin)

A mixture of the compound represented by Chemical Formula (1), Aronix M-220, Irgacure 379, and the fluorine monomer represented by Chemical Formula (2) at a ratio of 48:48:3:1 was employed as the photocurable resin.

### (Quartz Substrate)

A quartz substrate, the surface of which was processed with a silane coupling agent having superior adhesive properties with respect to photocurable resin, was utilized. The surface was processed by diluting the silane coupling agent, coating the surface of the substrate with the diluted silane coupling agent by the spin coat method, and then by annealing the coated surface.

### (Photocurable Resin Coating Step)

DMP-2831, which is an ink jet printer of the piezoelectric type by FUJIFILM Dimatix, was utilized. A dedicated 10 pl head was utilized as an ink jet head. Ink expelling conditions were set and adjusted in advance to achieve a desired amount of resin in each arranged droplet. Thereafter, droplets were arranged such that predetermined droplet heights were achieved.

### (Mold Contacting Step)

The mold and the quartz substrate were caused to approach each other, and positioning was performed while observing alignment marks with an optical microscope from the upper side of the mold such that the alignment marks were at predetermined positions.

### (Exposure Step)

Exposure was performed through the glass window and the mold by ultraviolet light that includes a wavelength of 360 nm at an irradiance level of 300 mJ/cm².

### Comparative Example 1

Photocurable resin was coated on a quartz substrate (surface height difference=30 nm) having a diameter of 6 inches, to coat the quartz substrate with a photocurable resin layer having a thickness of 60 nm. The same mold as that used in the Example was employed as a mold having a mesa portion. The mold was caused to lightly contact the photocurable resin layer, to form an assembly. Next, the entirety of the assembly was sealed in transparent silicone rubber. Then, the sealed assembly was set on the setting stage. Next, air was introduced into the pressure vessel such that the pressure therein became 1 MPa while supporting the sealed assembly with the substrate supporting member. The mold was pressed into the photocurable resin layer due to the fluid pressure exerted by the air. Then, the photocurable resin layer was exposed through the transparent silicone rubber. At this time, the temperature of the surface of the substrate was 45° C. Pressure was reduced to atmospheric pressure, the setting stage within the pressure vessel was heated until the temperature of the surface of the substrate reached 50° C., then the assembly was removed from the pressure vessel, and the seal was broken. The assembly was set within the pressure vessel again, and the mold and the cured curable resin were separated. Details regarding the photocurable resin, the quartz substrate, the apparatus, and each of the steps are the same as those of the Example.

### Comparative Example 2

Nanoimprinting was executed in the same manner as in the Example, except that a quartz substrate having a surface height difference of 80 nm was utilized.

### Comparative Example 3

Nanoimprinting was executed in the same manner as in the Example, except that the setting stage within the pressure vessel was not heated after decreasing the pressure therein to atmospheric pressure.

### Comparative Example 4

Nanoimprinting was executed in the same manner as in the Example, except that the assembly was not lifted by the substrate supporting member and air was introduced into the pressure vessel while the assembly was directly set on the setting stage.

### Comparative Example 5

Nanoimprinting was executed in the same manner as in the Example, except that air was introduced into the pressure vessel until the pressure therein became 0.05 MPa.

### Evaluation Method

### (Residual Film Fluctuations)

The thicknesses of photocurable resin residual films in the line and space patterns were measured from the centers of the quartz substrates to the vicinities of the edges of the mesa portions. The quartz substrates were exposed by separating portions of the patterned regions of the photocurable resin by scratching or by tape. The boundaries between the exposed regions and the patterned regions were observed by an AFM (Atomic Force Microscope) to measure the thicknesses h of the residual films. The thicknesses h were measured at 5 arbitrary locations in the radial direction. If the difference between a maximum value hₘₐₓ and a minimum value hₘᵢₙ was less than 10 nm, the residual film was evaluated as not having fluctuations in thickness. If the difference between a maximum value hₘₐₓ and a minimum value hₘᵢₙ was 10 nm or greater, the residual film was evaluated as having fluctuations in thickness.

### (Peeling Defects and Incomplete Filling Defects)

The line and space patterns of the photocurable resin obtained in the Example and Comparative Examples 1 through 5 were inspected by performing dark field measurements with a light receiving device (magnification: 50× to 1500×). First, 2 mm square fields were defined at a magnification of 50×. Next, 1 cm square regions were scanned while maintaining the 2 mm square fields, to ascertain the presence of defects on the surfaces of the quartz substrates due to peeling defects and incomplete filling defects. Peeling defects and incomplete filling defects were judged to be present in cases that scattered light, which should not be present in a normal pattern, was observed. The total number of peeling defects and incomplete filling defects was counted. In the case that the number of defects per lcm square area was 0, the quartz substrate was evaluated as having no defects. In the case that the number of defects per 1 cm square area was 1 or greater, the quartz substrate was evaluated as having defects.

### Evaluation Results

The results of evaluation are shown in Table 1 below. Based on a comparison of the Example and Comparative Example 1, the present invention realized pressing of the mold onto the surface coated with the photocurable resin with a uniform pressure. As a result, it was confirmed that the present invention can suppress the generation of residual film fluctuations, peeling defects, and incomplete filling defects.

Based on a comparison of the Example and Comparative Example 2, it was confirmed that generation of residual film fluctuations, peeling defects, and incomplete filling defects can be suppressed in nanoimprinting operations by setting the thickness of photocurable resin to be greater than or equal to the surface height difference of the surface of the substrate which is coated by the photocurable resin.

Based on a comparison of the Example and Comparative Example 3, it was confirmed that generation of peeling defects and incomplete filling defects can be suppressed in nanoimprinting operations by separating the mold and the substrate while heating the cured photocurable resin.

Based on a comparison of the Example and Comparative Example 4, it was confirmed that generation of residual film fluctuations, peeling defects, and incomplete filling defects can be suppressed in nanoimprinting operations by applying pressure while supporting the assembly such that fluid pressure of the environment operates on substantially the entire surface of the assembly.

Based on a comparison of the Example and Comparative Example 5, it was confirmed that generation of residual film fluctuations, peeling defects, and incomplete filling defects can be suppressed in nanoimprinting operations by setting the pressure within the pressure vessel to be within a predetermined range.

TABLE 1

| | | | | | | Evaluations | |
|---|---|---|---|---|---|---|---|
| | | | | | | | Peeling |
| | | | | | | | Defects |
| | | | | | | | and |
| | | Thickness of | | | | Residual | Incomplete |
| | | Photocurable | | Lifting of | | Film | Filling |
| | Seal | Resin Layer | Heating | Assembly | Pressure | Fluctuations | Defects |
| Example | No | ≧Surface | Yes | Yes | 1 MPa | No | No |
| | | Height | | | | | |
| | | Difference | | | | | |
| Comparative | Yes | ≧Surface | Yes | Yes | 1 MPa | Yes | Yes |
| Example 1 | | Height | | | | | |
| | | Difference | | | | | |
| Comparative | No | <Surface | Yes | Yes | 1 MPa | Yes | Yes |
| Example 2 | | Height | | | | | |
| | | Difference | | | | | |
| Comparative | No | ≧Surface | No | Yes | 1 MPa | No | Yes |
| Example 3 | | Height | | | | | |
| | | Difference | | | | | |
| Comparative | No | ≧Surface | Yes | No | 1 MPa | Yes | Yes |
| Example 4 | | Height | | | | | |
| | | Difference | | | | | |
| Comparative | No | ≧Surface | Yes | Yes | 0.05 MPa | Yes | Yes |
| Example 5 | | Height | | | | | |
| | | Difference | | | | | |

What is claimed is:

1. A nanoimprinting method that employs a mold having a fine pattern of protrusions and recesses on the surface thereof, and a substrate having a surface coated with curable resin, at least one of the mold and the substrate having a mesa portion, on which the pattern of protrusions and recesses or the surface coated with curable resin is formed, comprising:
placing the pattern of protrusions and recesses and the cured resin coated on the surface of the substrate in contact with each other to form an assembly constituted by the mold, the curable resin, and the substrate;
supporting the assembly, of which the entire surface is directly exposable to the environment, with a support member only at portions other than a portion corresponding to the pattern of protrusions and recesses within a pressure vessel;
introducing a gas into the pressure vessel;
pressing the mold and the substrate against each other with fluid pressure of the gas; and
separating the mold and the substrate.

2. A nanoimprinting method as defined in claim 1, wherein:
the support member is of an annular shape; and
the support member supports the assembly by positioning the portion corresponding to the pattern of protrusions and recesses within the inner circumference of the annular shape.

3. A nanoimprinting method as defined in claim 1, wherein:
the support member is constituted by three or more protrusions; and
the support member supports the portion of the assembly other than the portion corresponding to the pattern of protrusions and recesses with the three or more protrusions.

4. A nanoimprinting method as defined in claim 1, wherein:
the assembly is supported by the support member supporting only one of the mold and the substrate.

5. A nanoimprinting method as defined in claim 2, wherein:
the assembly is supported by the support member supporting only one of the mold and the substrate.

6. A nanoimprinting method as defined in claim 3, wherein:
the assembly is supported by the support member supporting only one of the mold and the substrate.

7. A nanoimprinting method as defined in claim 1, wherein:
the fluid pressure is within a range from 0.1 MPa to 5 MPa.

8. A nanoimprinting method as defined in claim 2, wherein:
the fluid pressure is within a range from 0.1 MPa to 5 MPa.

9. A nanoimprinting method as defined in claim 3, wherein:
the fluid pressure is within a range from 0.1 MPa to 5 MPa.

10. A nanoimprinting method as defined in claim 4, wherein:
the fluid pressure is within a range from 0.1 MPa to 5 MPa.

11. A nanoimprinting method as defined in claim 1, wherein:
the curable resin is coated on the substrate such that the thickness of the coated curable resin is greater than or equal to differences in the surface height of the substrate.

12. A nanoimprinting method as defined in claim 1, wherein:
the mold and the substrate are separated while applying heat to the curable resin.

13. A nanoimprinting apparatus utilized to execute the nanoimprinting method as defined in claim 1, comprising:
a pressure vessel, for housing an assembly constituted by a mold having a fine pattern of protrusions and recesses on the surface thereof, and a substrate having a surface coated with curable resin, formed by placing the pattern of protrusions and recesses and the cured resin coated on the surface of the substrate in contact with each other, filled with a gas;
a support member provided within the pressure vessel, for supporting the assembly, of which the entire surface is directly exposable to the environment, only at portions other than a portion corresponding to the pattern of protrusions and recesses; and
a gas introducing means, for introducing a gas into the pressure vessel.

14. A nanoimprinting apparatus as defined in claim 13, wherein:
the support member is of an annular shape.

15. A nanoimprinting apparatus as defined in claim 13, wherein:
the support member is constituted by three or more protrusions.
